(19) United States
(12) Patent Application Publication
(10) Pub. No.: US 2025/0345949 A1
(43) Pub. Date: Nov. 13, 2025

(54) GRIPPING DEVICE FOR FOLDED BOXES

(71) Applicant: SYSTEM LOGISTICS S.P.A., FIORANO MODENESE (MODENA) (IT)

(72) Inventor: Massimiliano CAMBONI, Modena (IT)

(21) Appl. No.: 18/867,139

(22) PCT Filed: Jun. 14, 2023
(86) PCT No.: PCT/IB2023/056153

§ 371 Date: Nov. 19, 2024

(30) Foreign Application Priority Data
Jul. 5, 2022 (IT) 102022000014173

(51) Int. Cl. B25J 15/00

(52) U.S. Cl. CPC B25J 15/0052

(57) ABSTRACT

Gripping device for folded boxes provided with two gripping openings lying on a gripping plane. The gripping device includes a support frame, at least a first and a second gripping element, associated with the frame and structured to each fit into a respective gripping opening and to interact with an edge of the gripping opening. The gripping elements are movable between a first position, in which they cannot interact with the edge of the opening, and a second position, in which they can engage with the edge of the opening.

The present invention relates to a gripping device for folded boxes.

The logistics of the fruit and vegetable sector makes extensive use of boxes of different sizes to hold goods, which, once emptied, can be folded down to reduce the space occupied. In practice, the boxes are provided with a bottom to which four lateral sides are hinged. The latter can rotate with respect to the bottom and overlap each other, in a known manner, placing themselves in contact with the bottom in a folded configuration of the box. Basically, the boxes are used to transport the goods from a departure plant to a logistic hub where they are emptied. Subsequently, the folded boxes are returned to the departure plant.

The process of returning the folded boxes begins at the logistic hub, where the boxes are loaded on pallets overlapped on each other in a not particularly orderly manner. In particular, the boxes are mixed together in different formats. Once arrived at the departure plant, the boxes must then be sorted one by one, based on the sizes and/or other characteristics, to be subsequently used in the envisaged manner.

The sorting of the boxes is a laborious operation, which is normally carried out by hand and which commits resources in a substantially unproductive way.

In addition, the logistic hubs are provided with expensive anthropomorphic manipulators, i.e. robotic arms, which perform the function of sorting the full boxes entering the logistic hub towards exiting pallets. The exiting pallets are composed of different boxes that are grouped based on prefixed combinations deriving from the supply requests that are received from the logistic hub. Typically, the requests come from the points of sale such as supermarkets and shops. In the fruit and vegetable sector, the activity of sorting the full boxes takes place in the early hours of the morning, so that the fresh products can reach the points of sale before their opening. Once the sorting activity has been exhausted, the robotic arms remain unproductive for the rest of the day. Since these are relatively expensive machines, it would be important to be able to exploit their potential for a longer period of time during the course of a day.

The object of the present invention is to offer a gripping device for folded boxes that allows to solve the drawbacks synthesized above.

An advantage of the gripping device according to the present invention is that it allows to realize a safe and effective gripping of boxes in folded configuration, without the need for any manual intervention.

Another advantage of the gripping device according to the present invention is that it can be mounted at the end of a robotic arm, so as to use the robotic arm to allow an automatic movement of the boxes.

Additional features and advantages of the present invention will become more apparent from the detailed following description of an embodiment of the invention in question, illustrated by way of non-limiting example in the appended figures, in which:

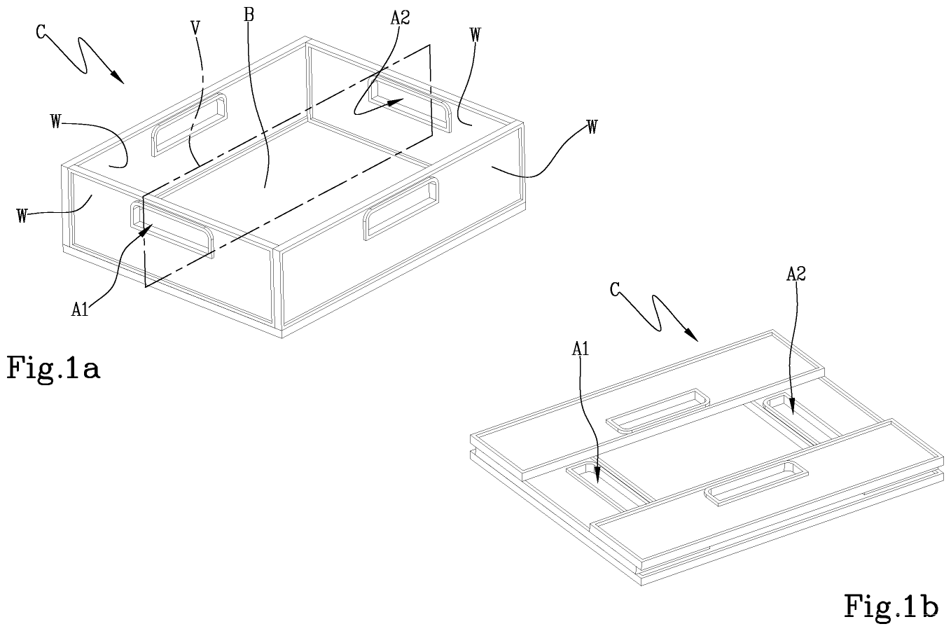

FIGS. 1a and 1b show respectively a box in open configuration and in folded configuration;

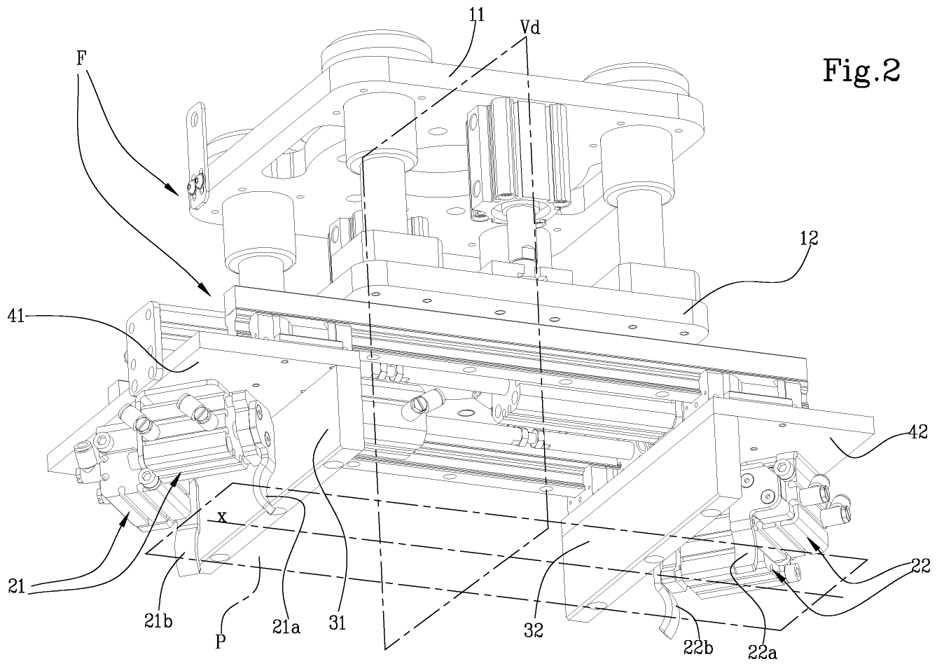

FIG. 2 shows a first isometric view of the gripping device according to the present invention;

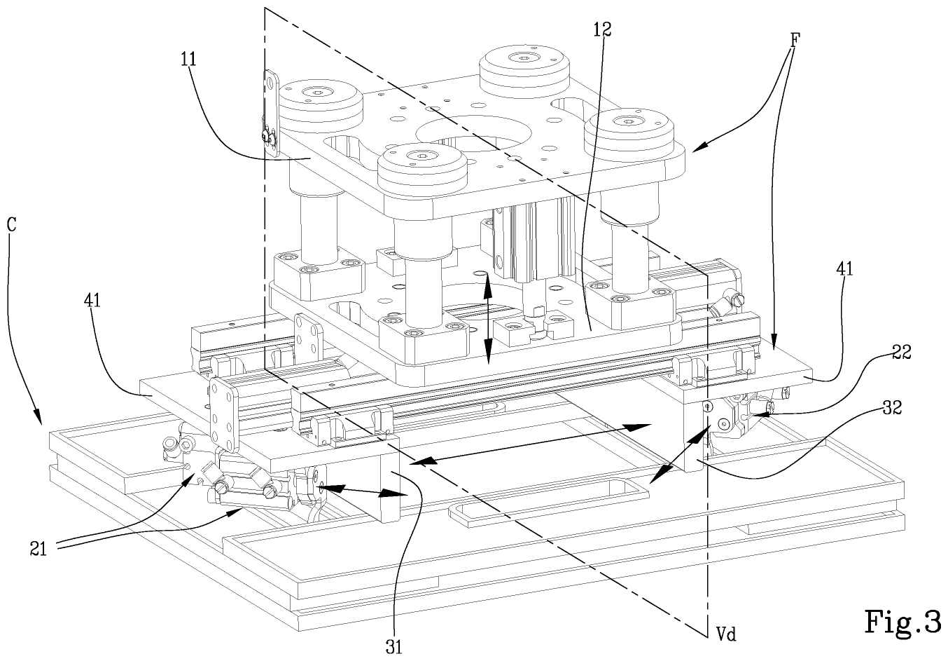

FIG. 3 shows a second isometric view of the gripping device according to the present invention, in a box gripping configuration;

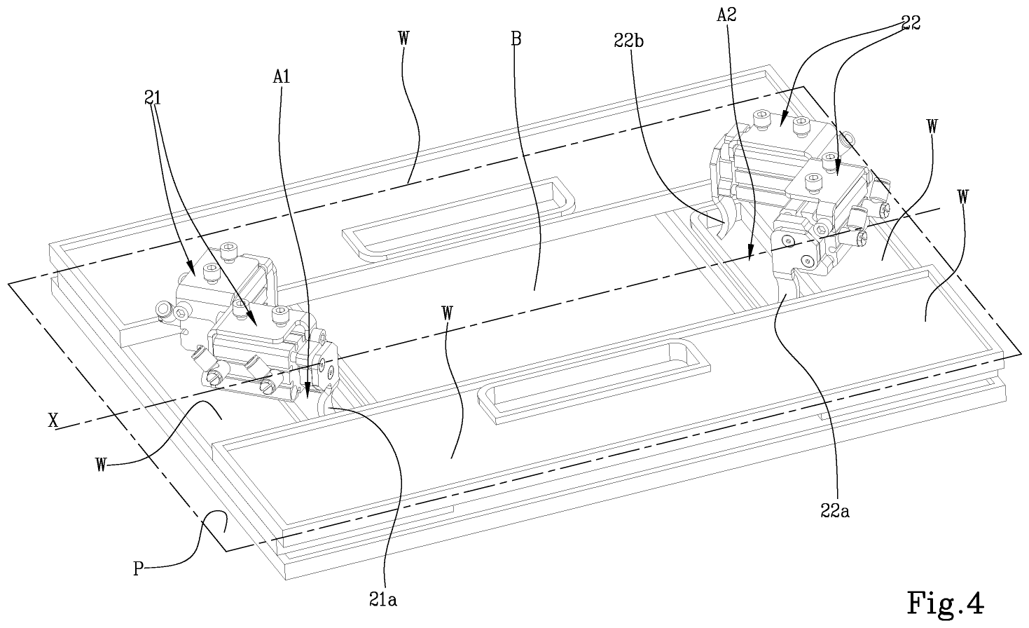

FIG. 4 shows a further isometric view of a part of the gripping device, in a box gripping configuration.

The gripping device according to the present invention lends itself in a particularly advantageous way to gripping foldable boxes (C), i.e. which can assume a folded configuration.

FIG. 1a shows a foldable box (C). In known manner, the box comprises a bottom wall (B) and four side walls (W). The bottom wall (B) has a substantially quadrangular contour and is provided with four sides. Each side wall (W) is hinged to one side of the bottom wall (B) and is rotatable between an extended position, in which it is substantially perpendicular to the bottom wall (B), and a folded position, in which it is placed on the bottom wall (B) or on another side wall (W) previously arranged in a folded position, as schematized in FIG. 1b. In essence, in the folded position the walls (W) are placed on each other and/or on the bottom wall (B), so as to reduce the height of the box (C) with respect to the bottom wall (B). Hooking means of known type, not illustrated, are arranged to constrain between them the side walls (W) in the extended position, in order to give the box (C) a stable configuration for use, suitable for holding objects.

At least two side walls (W) opposite each other in the extended configuration are provided with a respective gripping opening (A1,A2) or handle. In the folded configuration of the side walls (W), such gripping openings (A1,A2) lie on a gripping plane (P). The gripping plane (P) is substantially parallel to the bottom wall (B). The gripping openings (A1,A2) are delimited by an edge. Furthermore, the gripping openings (A1,A2), in the folded configuration, are arranged symmetrically with respect to a median plane (V) perpendicular to the gripping plane (P).

In the folded configuration of the box (C), two side walls (W) are folded in contact with or close to the bottom wall (C). The two side walls (W) provided with a gripping opening (A1,A2) are folded overlapped on the other two, so that the gripping openings (A1,A2) are accessible from the outside.

Under normal conditions of use of the box (C), the bottom wall (B) is substantially horizontal, and this orientation will be referred to in the following description. Likewise, reference will be made to a horizontal orientation of the gripping plane (P). This does mean that the gripping device according to the present invention, suitably rotated, is able to operate on boxes (C) oriented in any way.

In the folded configuration of the side walls (W), the gripping openings (A1,A2) face upwards and are accessible from above.

The gripping device according to the present invention comprises a support frame (F). As will be better said later, the support frame (F) is arranged to be connected to a motor device, that is to a device movable in space and able to displace the frame (F) in space. For example, the motor device is a robotic arm, not illustrated, having an end to which the frame (F) can be connected.

The gripping device according to the present invention comprises at least a first and a second gripping element (21,22), associated to the frame (F).

The gripping elements (21,22) are structured to each fit into a respective gripping opening (A1,A2), and to interact with the edge of the gripping opening (A1,A2).

In particular, the gripping elements (21,22) are movable between a first position, in which they cannot interact with the edge of the opening (A1,A2), and a second position, in which they can engage with the edge of the opening (A1,A2). In other words, in the second position each gripping element (21,22) is able to hook the edge of a respective gripping opening (A1,A2).

The configuration of the gripping elements (21,22) is particularly advantageous. In fact, thanks to the possibility of engaging or hooking the edge of a gripping opening (A1,A2), the gripping elements (21,22) allow the gripping of a box (C) in folded configuration. This is because, in the folded configuration of the box (C), the gripping openings (A1,A2) face upwards, and are accessible from above. In this way, a box (C) in folded configuration that is free at the top, such as the box placed at the top of a stack of boxes, can be effectively grasped by the gripping device according to the present invention. To this end, it is sufficient to place the gripping device above a box (C), with the gripping elements (21,22) in the first position, so as to introduce the gripping elements (21,22) into the available gripping openings (A1,A2). Subsequently, by displacing them from the first to the second position, the gripping elements (21,22) engage or hook the edge of the respective gripping opening (A1,A2), constraining the box (C) to the gripping device according to the present invention. The box (C) can be released by depositing the box on a rest plane and by displacing the gripping elements into the first position.

Preferably, the gripping elements are arranged symmetrically with respect to a median plane (V) perpendicular to the gripping plane (P). Preferably, the gripping elements (21,22) are movable in a synchronized manner, so as to always assume a symmetrical position with respect to the median plane (V).

Preferably, the gripping elements (21,22) are movable from the first towards the second position in mutual approaching on a plane parallel to the gripping plane (P). In other words, regardless of the actual displacement direction of the gripping elements (21,22), the latter approach each other passing from the first to the second position. This means that, along at least one direction, the distance between the gripping elements (21,22) is reduced in the displacement from the first to the second position. Preferably, but not necessarily, the gripping elements (21,22) are movable between the first and the second position along a trajectory having a component parallel to the gripping plane (P). For example, the direction along which the gripping elements (21,22) approach is a gripping direction (X), parallel to the gripping plane (P).

The fact that the gripping elements (21,22) are movable in mutual approaching by displacing themselves from the first to the second position entails the following advantage. Considering that the gripping openings (A1,A2) are arranged on opposite side walls (W) of a box (C), the mutual approach between the gripping elements (21,22), when the latter are fitted into the respective gripping opening (A1,A2) with the walls (W) in the folded position, transmits to the side walls (W) themselves a force that tends to approach them, favouring the stable maintenance of the folded configuration of the walls (W) and of the box (C). In fact, the force exerted by each gripping element (21,22) on the respective gripping opening (A1,A2) is directed away from the axis of rotation of the relative side wall (W), so that the latter is subjected to a torque that tends to rotate it towards the bottom wall (B).

Preferably, a contact sensor, of known type, is arranged to detect a contact between each gripping element (21,22) and the edge of a gripping opening (A1,A2). Contact detection can be used to determine the end-of-stroke of each gripping element in the second position.

In the preferred but not exclusive embodiment depicted, the first gripping element (21) comprises two flaps (21a,21b), each of which is movable between the first and the second position along a sliding direction lying on a plane parallel to the gripping plane (P). The sliding directions of the flaps (21a,21b) are divergent from the first to the second position. For example, the sliding directions of the flaps (21a,21b) are inclined to each other by about 90°. Further, the sliding directions of the flaps (21a,21b) are preferably arranged symmetrical with respect to the gripping direction (X). By displacing themselves from the first to the second position, the flaps (21a,21b) approach the second gripping element (22) along the gripping direction (X), whereas they move away from each other along a direction perpendicular and coplanar to the gripping direction (X). As schematized in FIG. 4, thanks to the divergent orientation of the sliding directions, the flaps (21a,21b), by displacing themselves from the first to the second position, centre the gripping opening (A1,A2) with respect to the gripping direction (X).

In turn, the second gripping element (22) comprises two flaps (22a, 22b), each of which is movable between the first and second positions along a sliding direction lying on a plane parallel to the gripping plane (P). The sliding directions of the flaps (22a, 22b) are divergent from the first to the second position. Further, the sliding directions of the flaps (22a, 22b) are preferably arranged symmetrical with respect to the gripping direction (X). By displacing themselves from the first to the second position, the flaps (22a,22b) approach the first gripping element (21) along the gripping direction (X), whereas they move away from each other along a direction perpendicular and coplanar to the gripping direction (X). As schematized in FIG. 4, thanks to the divergent orientation of the sliding directions, the flaps (22a,22b), by displacing themselves from the first to the second position, centre the gripping opening (A1,A2) with respect to the gripping direction (X).

Thanks to the combined action of the flaps of the first gripping element (21) and of the second gripping element (22), when the latter displace themselves from the first to the second position the box (C) is centred with respect to the gripping direction (X).

To facilitate the correct centring of the gripping openings (A1,A2), the flaps (21a,21b) of the first gripping element (21) are movable simultaneously with each other, as well as the flaps (22a,22b) of the second gripping element (22).

Furthermore, the flaps (21a, 21b) of the first gripping element (21) are preferably arranged symmetrically to the flaps (22a, 22b) of the second gripping element (22) with respect to the median plane (V).

Preferably, a contact sensor is arranged to detect a contact between each flap (21a,21b,22a,22b) and the edge of the respective gripping opening (A1,A2). As already mentioned above, contact detection can be used to cause the end-of-stroke of each gripping element in the second position.

Gripping a box (C) takes place substantially in the following ways. As already pointed out, the boxes (C) are normally arranged resting horizontally, i.e. restingly with the horizontal bottom wall (B) and with the horizontal gripping plane (P). This does mean that the gripping device can work correctly with a different orientation.

The gripping device is positioned above the box (C) so that the median plane (Vd) of the gripping device substantially coincides with the median plane (V) of the box (C). The gripping device is then lowered by a sufficient extent to fit the gripping elements (21,22), which are in the first position, into the gripping openings (A1,A2). Subsequently, the gripping elements (21,22) are brought into the second position, engaging the openings (A1,A2) as already illustrated. A box is deposited with a substantially opposite cycle of operations, that is, the box is placed on the target rest, the gripping elements (21,22) are returned to the first position and the gripping device moves away.

In the preferred but not exclusive embodiment depicted, the gripping device according to the present invention comprises a first support (41) and a second support (42), associated with the frame (F) and movable in mutual approaching and distancing. The first support and the second support are slidably associated with the frame (F), by means of guides of known type and not described in detail. The motion of each support (41,42) is obtained by means of a respective actuator (S1,S2) of known type, for example a fluid-dynamic piston or an electric motor. Preferably, the supports (41,42) are movable in a synchronized manner, so as to always be in a symmetrical position with respect to the median vertical plane (V) of the gripping device. The first gripping element (21) is associated with the first support (41), whereas the second gripping element (22) is associated with the second support (42). By translating the supports (41,42) in a controlled manner, it is possible to position the gripping elements (21,22) as a function of the actual sizes of the box (C) to be picked up, and in particular as a function of the distance that separates the gripping handles (A1,A2) on the gripping plane (P). As will be better said below, the adjustment of the position of the supports (41,42), and of the gripping elements (21,22) associated with them, can be carried out in real time, detecting the shape and the sizes of the box (C) by means of special sensors.

Preferably, the gripping device according to the present invention comprises at least one rest (31,32), arranged to be positioned in contact with a folded box, on a contact plane substantially parallel to the gripping plane (A1,A2). The rest (31,32) is substantially an abutment of the gripping device with respect to the box (C) to be picked up, which abutment defines an envisaged depth of insertion of the gripping elements (21,22) into the gripping openings (A1,A2). In practice, when the rest (31,32) comes into contact with the box (C) to be picked up, the downward stroke of the gripping device stops. Preferably, the rest (31,32) comprises a first rest (31), associated with the first support (41), and a second support (32), associated with the second support (42). In this way, thanks to the displacement of the supports (41,42), it is possible to adjust the position of the rests (31,32) as a function of the shape and of the sizes of the box (C) to be picked up. Preferably, the first rest (31) is arranged alongside the flaps (21a,21b) of the first gripping element, while the second rest is arranged alongside the flaps (22a,22b) of the second rest (32). Preferably, the two rests (31,32) are interposed between the two gripping elements (21,22).

In the preferred but not exclusive embodiment depicted, the frame (F) comprises a first body (11) and a second body (12), movable in mutual approaching and distancing along a direction perpendicular to the gripping plane (P); The first body (11) is arranged to be connected to a motor device, movable in space, such as the end of a robotic arm. The gripping elements (21,22) are associated with the second body (12).

The relative displacement between the first body (11) and the second body (12) is guided by guide systems of known type, not described in detail, and can be caused by one or more actuators(S) of known type, for example a fluid-dynamic piston or an electric motor.

The relative displacement between the first and second bodies (11,12) can be used to travel an end stretch of the vertical stroke of the gripping device, substantially to fit the gripping elements (21,22) into the gripping openings (A1,A2) in the correct position. As already mentioned, the vertical reference for fitting the gripping elements (21,22) is given by the contact between the rest (31,32) and the upper surface of the box (C).

Preferably, but not necessarily, the gripping device according to the present invention comprises a control system, arranged to detect the position of the gripping openings (A1,A2) of a folded box, and to activate the displacement of the gripping elements (21,22) between the first and the second position as a function of the detected position of the gripping openings (A1,A2). In addition, the control system, by means of a dedicated algorithm, is arranged to guide the gripping device in the correct position to be able to grasp a box (C). In particular, the control system, by means of a known algorithm, guides the gripping device so as to make the median plane (Vd) of the gripping device coincide with the median plane (V) of the box (C) it is wished to be picked up. For this purpose, the control system can make use of signals from one or more position sensors of various type, of optical systems and/or of GPS or other systems. For example, the control system comprises an optical device, arranged to detect and identify the shape and the position of a folded box and of the gripping openings (A1,A2).

1. A gripping device for folded boxes provided with two gripping openings (A1,A2) lying on a gripping plane (P), comprising:
a support frame (F);
at least a first and a second gripping element (21,22), associated with the frame (F) and structured to each fit into a respective gripping opening (A1,A2) and to interact with an edge of the gripping opening (A1,A2);
wherein the gripping elements (21,22) are movable between a first position, in which the gripping elements cannot interact with the edge of the opening (A1,A2), and a second position, in which the gripping elements can engage with the edge of the opening (A1,A2).

2. The gripping device according to claim 1, wherein the gripping elements (21,22) are movable from the first towards the second position in mutual approaching on a plane parallel to the gripping plane (P).

3. The gripping device according to claim 1, wherein
the first gripping element (21) comprises two flaps (21a,21b), each of the flaps of the first gripping element is movable between the first and second position along a sliding direction lying on a plane parallel to the gripping plane (P); the sliding directions of the flaps (21a,21b) are divergent from the first to the second position;
the second gripping element (22) comprises two flaps (22a,22b), each of the flaps of the second gripping element is movable between the first and second position along a sliding direction lying on a plane parallel to the gripping plane (P); the sliding directions of the flaps (22a,22b) are divergent from the first to the second position.

4. The gripping device according to claim 1, comprising:
a first support (41) and a second support (42), associated with the frame (F) and movable in mutual approaching and distancing;
wherein the first gripping element (21) is associated with the first support (41) and the second gripping element (22) is associated with the second support (42).

5. The gripping device according to claim 1, comprising at least one rest (31,32), arranged to be positioned in contact with a folded box, on a contact plane substantially parallel to the gripping plane (A1,A2).

6. The gripping device according to claim 4, wherein a first rest (31) is associated with the first support (41), and wherein a second rest (32) is associated with the second support (42).

7. The gripping device according to claim 1, wherein:
the frame (F) comprises a first body (11) and a second body (12), movable in mutual approaching and distancing along a direction perpendicular to the gripping plane (P);
the first body (11) is arranged to be connected to a motor device, movable in space;
the gripping elements (21,22) are associated with the second body (12).

8. The gripping device according to claim 1, comprising a contact sensor, arranged to detect a contact between each gripping element (21,22) and the edge of a gripping opening (A1,A2).

9. The gripping device according to claim 1, comprising a control system arranged to detect the position of the gripping openings (A1,A2) of a folded box, and to activate the displacement of the gripping elements (21,22) between the first and second position as a function of the detected position of the gripping openings (A1,A2).

10. The gripping device according to claim 9, wherein the control system comprises an optical device, arranged to detect and identify the shape and the position of a folded box and of the gripping openings (A1,A2).
